(19) United States
(12) Patent Application Publication
(10) Pub. No.: US 2009/0230765 A1
(43) Pub. Date: Sep. 17, 2009

(54) SYSTEM AND METHOD FOR DELIVERING POWER TO AN ELECTRIC MOTOR OF AN AUTOMOTIVE VEHICLE

(75) Inventors: Daniel Gabor, Canton, MI (US); Dale Scott Crombez, Livonia, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/048,565

(22) Filed: Mar. 14, 2008

(51) Int. Cl. B60L 1/00; H02P 1/00

(52) U.S. Cl. 307/10.1; 307/113; 318/139

(57) ABSTRACT

A plurality of electronically controlled parallel electro-mechanical switches are each configured to deliver power from a power source to an electric motor of an automotive vehicle. The electric motor has an expected number of activation cycles for the life of the automotive vehicle. Each of the electro-mechanical switches has a specified number of activation cycles that defines its useable life. The specified number of action cycles for each of the electro-mechanical switches is less than the expected number of activation cycles of the electric motor.

### BACKGROUND

1. Field of the Invention

The invention relates to systems and methods for delivering power to an electric motor of an automotive vehicle.

2. Discussion

Switches may be used to deliver power from a power source to a power sink. As an example, U.S. Pat. No. 6,211,580 to Cabuz et al. provides an electrostatic actuator and drive configuration device for use in a system requiring a long term ON state operation. The device includes a first electrostatic actuator positioned to operate in the system requiring the long term ON state upon activation of a power supply. The device also includes a second electrostatic actuator positioned to operate in the system requiring the long term ON state upon activation of the power supply. A timer is connected to the power supply to alternately select the first or the second actuator for activation to drive the selected actuator to the ON state. The timer is controlled to select the first or second electrostatic actuator on an alternating basis to prevent either electrostatic actuator from remaining in the ON state for more than a predetermined time without the other actuator being selected. The electrostatic actuators may be configured in parallel or in series, depending upon the demands of the system.

As another example, U.S. Pat. No. 4,769,554 to Reinartz et al. provides an electrical switching mechanism for circuits associated with hydraulic systems in automotive vehicles. The switching mechanism comprises at least one switch disposed on a printed circuit board. The at least one switch includes a sliding contact fixed to a hydraulically movable carrier. The sliding contact, in various positions along its path of displacement, provides for electrically conductive connection or disconnection.

As yet another example, U.S. Pat. No. 4,625,205 to Relis provides a remote control system including a central encoder for transmitting a single sequence of control pulses to a plurality of remote decoders, each of which performs a predetermined function when it has received a selected number of pulses. Reliability of the system is enhanced by including in the encoder and all of the decoders a number of electro-mechanical relays arranged in a triple redundant configuration.

### SUMMARY

A system for delivering power from a power source to an electric motor of an automotive vehicle includes at least two electro-mechanical switches in parallel. Each of the electro-mechanical switches is configured to deliver power from the power source to the electric motor when activated. Each of the electro-mechanical switches has a specified number of activation cycles that defines its lifetime. The specified number of activation cycles for at least one of the electro-mechanical switches is less than an expected number of activation cycles of the electric motor for a life of the automotive vehicle. The system also includes an electronic control module that is configured to selectively activate the at least two electro-mechanical switches for an activation cycle of the electric motor.

A system for delivering power from a power source to an electric motor of an automotive vehicle includes a plurality of parallel electro-mechanical switches. Each of the plurality of parallel electro-mechanical switches is configured to pass power from the power source to the electric motor when activated for an activation cycle of the electric motor. Each of the plurality of parallel electro-mechanical switches has a specified number of activation cycles that defines its lifetime. The specified number of activation cycles of each of the plurality of parallel electro-mechanical switches is less than an expected number of activation cycles of the electric motor for a life of the automotive vehicle.

A method of providing power from a power source to an electric motor of an automotive vehicle via a plurality of parallel electro-mechanical switches includes determining whether one of the plurality of parallel electro-mechanical switches was used for a previous activation cycle of the electric motor. The method also includes activating another one of the plurality of parallel electro-mechanical switches for a current activation cycle of the electric motor. Each of the plurality of parallel electro-mechanical switches has a specified number of activation cycles that defines its lifetime. Each of the specified number of activation cycles is less than an expected number of activation cycles of the electric motor for a life of the automotive vehicle.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram of a portion of a power supply system for a vacuum pump motor of an automotive vehicle according to an embodiment of the invention.

FIG. 2 is a flow chart of a strategy for controlling the power supply system of FIG. 1 for an activation cycle of the vacuum pump motor of FIG. 1 according to another embodiment of the invention.

FIG. 3 is a flow chart of another strategy for controlling the power supply system of FIG. 1 for an activation cycle of the vacuum pump motor of FIG. 1 according to yet another embodiment of the invention.

FIG. 4 is a flow chart of yet another strategy for controlling the power supply system of FIG. 1 for an activation cycle of the vacuum pump motor of FIG. 1 according to still yet another embodiment of the invention.

### DETAILED DESCRIPTION

Certain automotive vehicles, such as hybrid electric vehicles, may use a vacuum based braking system. A vacuum pump is often used in a vacuum based braking system. Such a vacuum pump may experience a substantial number of activation cycles, e.g., 1.2 million, during the life of the vehicle.

An electronically controlled solid state relay may be used to deliver power to activate a vacuum pump. Solid state relays, however, may be costly. Electro-mechanical switches are generally less costly than solid state relays. The usable life of an electro-mechanical switch, however, is typically less than the expected number of activation cycles of a vacuum pump during the life of the vehicle.

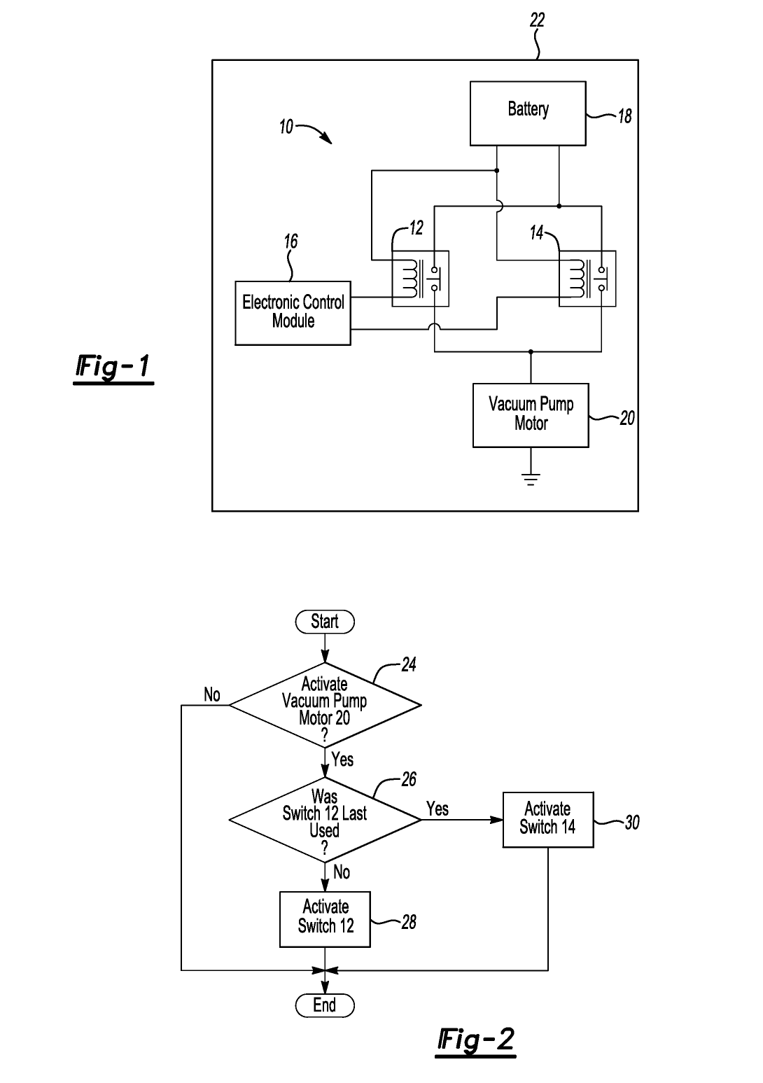

Referring now to FIG. 1, an embodiment of a portion of a power delivery system 10 includes a pair of parallel electro-mechanical switches 12, 14, e.g., relays, etc., controlled by an electronic control module 16. When activated, the switches 12, 14 pass electrical currents from a battery 18 to a vacuum pump motor 20 of a vacuum based braking system (not shown) for an automotive vehicle 22. One of the switches 12, 14 is activated for each activation cycle of the motor 20. In other embodiments, any number of parallel electro-mechanical switches may be controlled by the electronic control module 16.

Each of the switches 12, 14 has a specified number of activation cycles that defines its usable life. In the embodiment of FIG. 1, the specified number of activation cycles for each of the switches 12, 14 is 600,000. Other specified numbers of activation cycles are of course also possible. The expected number of activation cycles of the motor 20 for a life of the vehicle 22 is 1,000,000.

While the specified number of activation cycles for any one of the switches 12, 14 is not sufficient to meet the expected number of activation cycles of the motor 20, the total of the specified number of activation cycles for both of the switches 12, 14 is greater than the expected number of activation cycles of the motor 20. As a result, the control module 16 uses one or the other of the switches 12, 14 for each activation cycle of the motor 20 for the life of the vehicle 22.

Referring now to FIGS. 1 and 2, the control module 16 determines whether to activate the motor 20 as indicated at 24. If no, the strategy ends. If yes, the control module 16 determines whether the switch 12 was used during the last activation cycle of the motor 20 as indicated at 26. If no, the control module 16 activates the switch 12 to deliver power from the battery 18 to the motor 20 for an activation cycle of the motor 20 as indicated at 28. The strategy then ends. If yes, the control module 16 activates the switch 14 to deliver power from the battery 18 to the motor 20 for an activation cycle of the motor 20 as indicated at 30. The strategy then ends. The control strategy of FIG. 2 thus alternately activates the switches 12, 14 for consecutive activation cycles of the motor 20.

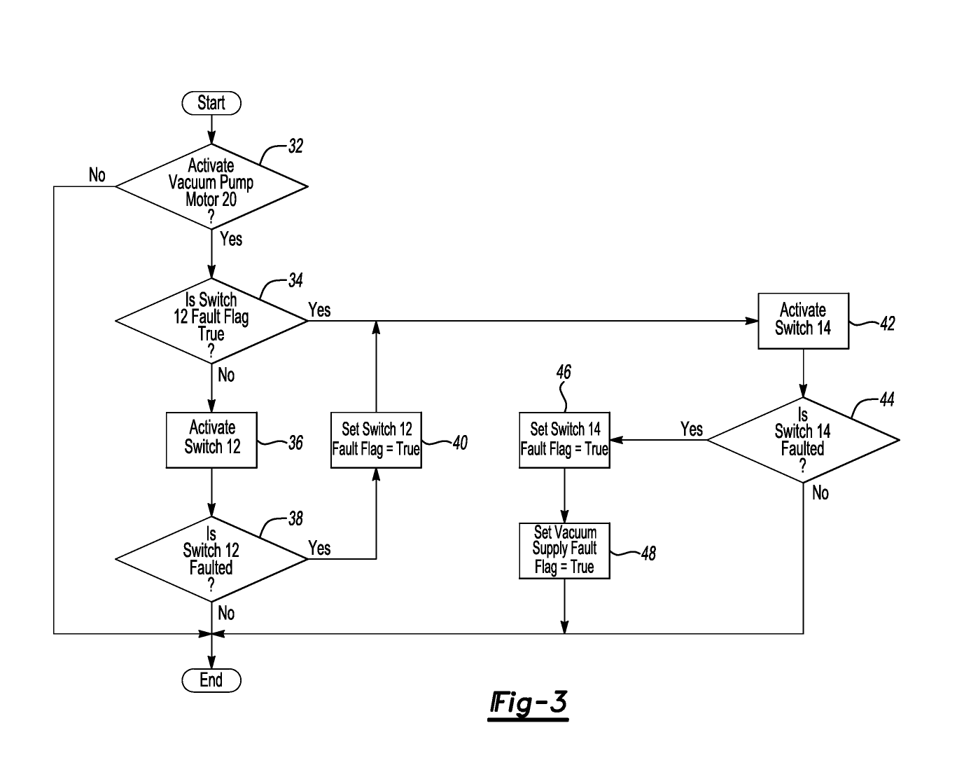

Referring now to FIGS. 1 and 3, the control module 16 determines whether to activate the motor 20 as indicated at 32. If no, the strategy ends. If yes, the control module 16 determines whether a fault flag associated with the switch 12 is set to true as indicated at 34. In the embodiment of FIG. 3, the fault flag associated with the switch 12 may be set to true if the switch 12 encountered a fault condition, e.g., not activating, etc., during a previous activation cycle of the motor 20. If no, the control module 16 activates the switch 12 to deliver power from the battery 18 to the motor 20 for an activation cycle of the motor 20 as indicated at 36. As indicated at 38, the control module 16 determines whether the switch 12 is experiencing a fault condition. If no, the strategy ends. If yes, the control module 16 sets the fault flag associated with the switch 12 equal to true as indicated at 40. As indicated at 42, the control module 16 activates the switch 14 to deliver power from the battery 18 to the motor 20 for the activation cycle of the motor 20. As indicated at 44, the control module 16 determines whether the switch 14 is experiencing a fault condition. If no, the strategy ends. If yes, the control module 16 sets the fault flag associated with the switch 14 equal to true as indicated at 46. As indicated at 48, the control module 16 sets a vacuum supply fault flag equal to true. The strategy then ends. In the embodiment of FIG. 3, the vacuum supply fault flag indicates that the vacuum based braking system encountered a fault during the activation cycle of the motor 20.

Referring again to step 34, if yes, the strategy proceeds to step 42. The control strategy of FIG. 3 thus activates the switch 12 for consecutive activation cycles of the motor 20 unless the switch 12 is faulted. That is, the control strategy of FIG. 3 attempts to exhaust the specified number of activation cycles of the switch 12 before using the switch 14.

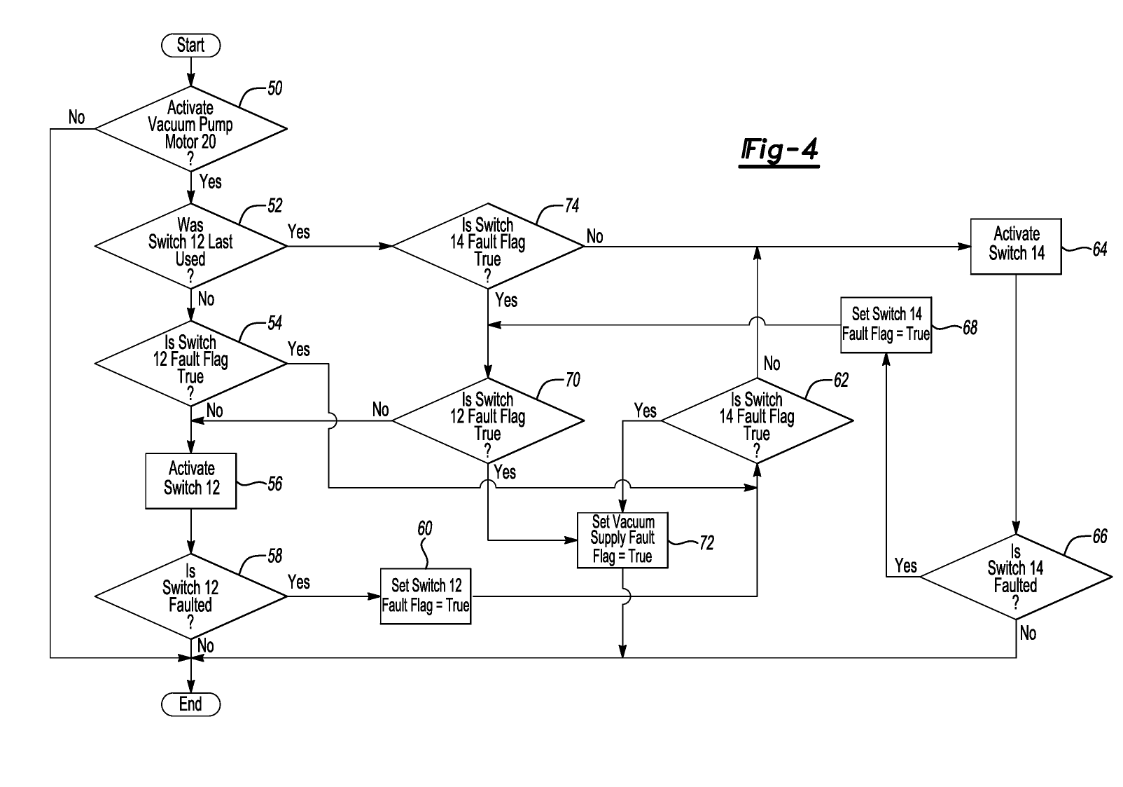

Referring now to FIGS. 1 and 4, the control module 16 determines whether to activate the motor 20 as indicated at 50. If no, the strategy ends. If yes, the control module 16 determines whether the switch 12 was used during the last activation cycle of the motor 20 as indicated at 52. If no, the control module 16 determines whether a fault flag associated with the switch 12 is set to true as indicated at 54. If no, the control module 16 activates the switch 12 to deliver power from the battery 18 to the motor 20 for an activation cycle of the motor 20 as indicated at 56. As indicated at 58, the control module 16 determines whether the switch 12 is experiencing a fault condition. If no, the strategy ends. If yes, the control module 16 sets the fault flag associated with the switch 12 equal to true at block 60. As indicated at 62, the control module 16 determines whether a fault flag associated with the switch 14 is set to true. If no, the control module 16 activates the switch 14 to deliver power from the battery 18 to the motor 20 for the activation cycle of the motor 20 as indicated at 64. As indicated at 66, the control module 16 determines whether the switch 14 is experiencing a fault condition. If no, the strategy ends. If yes, the control module 16 sets the fault flag associated with the switch 14 equal to true as indicated at 68. As indicated at 70, the control module 16 determines whether the fault flag associated with the switch 12 is set to true. If no, the strategy proceeds to step 56. If yes, the control module 16 sets a vacuum supply fault flag equal to true as indicated at 72. The strategy then ends.

Referring again to step 52, if yes, the control module 16 determines whether the fault flag associated with switch 14 is set to true as indicated at 74. If no, the strategy proceeds to step 64. If yes, the strategy proceeds to step 68.

Referring again to step 54, if yes, the strategy proceeds to step 62.

Referring again to step 62, if yes, the strategy proceeds to step 72. The control strategy of FIG. 4 thus alternately activates the switches 12, 14 for consecutive activation cycles of the motor 20 unless one of the switches 12, 14 is faulted.

While embodiments of the invention have been illustrated and described, it is not intended that these embodiments illustrate and describe all possible forms of the invention. For example, embodiments of the invention may be used to deliver power from a power source to any electric motor of an automotive vehicle.

The words used in the specification are words of description rather than limitation, and it is understood that various changes may be made without departing from the spirit and scope of the invention.

What is claimed:

1. A system for delivering power from a power source to an electric motor of an automotive vehicle, the electric motor having an expected number of activation cycles for a life of the automotive vehicle, the system comprising:
at least two electro-mechanical switches in parallel, each of the electro-mechanical switches being configured to deliver power from the power source to the electric motor when activated, each of the electro-mechanical switches having a specified number of activation cycles that defines its lifetime, and the specified number of activation cycles for at least one of the electro-mechanical switches being less than the expected number of activation cycles of the electric motor; and
an electronic control module being configured to selectively activate the at least two electro-mechanical switches for an activation cycle of the electric motor.

2. The system of 1 wherein a sum of the specified number of activation cycles of each of the at least two electro-mechanical switches is equal to or greater than the expected number of activation cycles of the electric motor.

3. The system of claim 1 wherein the electronic control module alternately activates the at least two electro-mechanical switches for a plurality of consecutive activation cycles of the electric motor.

4. The system of claim 1 wherein the electronic control module is further configured to determine whether one of the at least two electro-mechanical switches was activated for a previous activation cycle of the electric motor.

5. The system of claim 4 wherein the electronic control module is further configured to activate another one of the at least two electro-mechanical switches for a current activation cycle of the electric motor if the one of the at least two electro-mechanical switches was activated for the previous activation cycle of the electric motor.

6. The system of claim 1 wherein the electronic control module is further configured to activate a same one of the at least two electro-mechanical switches for a plurality of consecutive activation cycles of the electric motor.

7. The system of claim 1 wherein the electronic control module is further configured to determine whether one of the at least two electro-mechanical switches is inoperable and to activate another one of the at least two electro-mechanical switches for a current activation cycle of the electric motor if the one of the at least two electro-mechanical switches is inoperable.

8. The system of claim 1 wherein the electric motor comprises a vacuum pump motor.

9. The system of claim 1 wherein the at least two electro-mechanical switches comprise relays.

10. A system for delivering power from a power source to an electric motor of an automotive vehicle, the electric motor having an expected number of activation cycles for a life of the automotive vehicle, the system comprising:
a plurality of parallel electro-mechanical switches each being configured to pass power from the power source to the electric motor when activated for an activation cycle of the electric motor and each having a specified number of activation cycles that defines its lifetime, the specified number of activation cycles of each of the plurality of parallel electro-mechanical switches being less than the expected number of activation cycles of the electric motor.

11. The system of claim 10 further comprising an electronic control module being configured to activate one of the plurality of parallel electro-mechanical switches for each activation cycle of the electric motor.

12. The system of claim 11 wherein the electronic control module is further configured to activate a same one of the plurality of parallel electro-mechanical switches for a plurality of consecutive activation cycles of the electric motor.

13. The system of claim 11 wherein the electronic control module is further configured to determine whether one of the plurality of parallel electro-mechanical switches was activated for a previous activation cycle of the electric motor.

14. The system of claim 13 wherein the electronic control module is further configured to activate another one of the plurality of parallel electro-mechanical switches for a current activation cycle of the electric motor if the one of the plurality of electro-mechanical switches was activated for the previous activation cycle of the electric motor.

15. The system of claim 11 wherein the electronic control module is further configured to sequentially activate the plurality of parallel electro-mechanical switches for a plurality of consecutive activation cycles of the electric motor.

16. The system of claim 10 wherein a sum of the specified number of activation cycles of each of the plurality of parallel electro-mechanical switches is equal to or greater than the expected number of activation cycles of the electric motor.

17. The system of claim 11 wherein the electronic control module is further configured to determine whether one of the plurality of electro-mechanical switches is inoperable and to activate another one of the plurality of electro-mechanical switches for a current activation cycle of the electric motor if the one of the plurality of electro-mechanical switches is inoperable.

18. A method of providing power from a power source to an electric motor of an automotive vehicle via a plurality of parallel electro-mechanical switches, the electric motor having an expected number of activation cycles for the life of the vehicle, the method comprising:
determining whether one of the plurality of parallel switches was used for a previous activation cycle of the electric motor; and
activating another one of the plurality of parallel electro-mechanical switches for a current activation cycle of the electric motor, each of the plurality of parallel electro-mechanical switches having a specified number of activation cycles that defines its lifetime, each of the specified number of activation cycles being less than the expected number of activation cycles of the electric motor.
